(19) United States
(12) Patent Application Publication
(10) Pub. No.: US 2020/0017655 A1
(43) Pub. Date: Jan. 16, 2020

(54) POROUS CROSSLINKED HYDROPHILIC POLYMERIC MATERIALS PREPARED FROM HIGH INTERNAL PHASE EMULSIONS CONTAINING HYDROPHILIC POLYMERS

(71) Applicant: NAIHONG LI, Sunnyvale, CA (US)

(72) Inventors: Naihong LI, Sunnyvale, CA (US); Wenjia SONG, Pullman, WA (US); Jen-Chieh WU, Sunnyvale, CA (US)

(21) Appl. No.: 16/491,522

(22) PCT Filed: Mar. 2, 2018
(86) PCT No.: PCT/CA2018/050244

§ 371 Date: Sep. 5, 2019

Related U.S. Application Data
(60) Provisional application No. 62/467,685, filed on Mar. 6, 2017.

(51) Int. Cl. C08J 9/28; C08J 9/36; C08J 3/24; C08J 3/03

(52) U.S. Cl. CPC C08J 9/283; C08J 9/36; C08J 3/24; C08J 2201/026; C08J 2201/028; C08J 2329/04; C08J 3/03

(57) ABSTRACT

The present disclosure relates to a process for preparing porous crosslinked hydrophilic polymeric materials. Such materials can be prepared from oil-in-water high internal phase emulsions (HIPEs) containing hydrophilic polymers. The oil-in-water high internal phase emulsion (HIPE) comprises two phases: an external continuous aqueous phase containing at least one hydrophilic polymer; and an internal oil phase. The hydrophilic polymer is crosslinked to form a three-dimensionally crosslinked polymer matrix. The internal oil phase is subsequently removed to obtain a porous crosslinked hydrophilic polymeric material. The present invention also relates to porous crosslinked hydrophilic polymeric materials prepared by such a process.

### FIELD

The present disclosure is directed to a method of preparing polymeric absorbent materials having enhanced absorption rates and retention properties, and more particularly to a method for preparing porous crosslinked hydrophilic polymeric materials from oil-in-water HIPEs, such as by directly crosslinking the hydrophilic polymers dissolved in the aqueous phase of such HIPEs. The present disclosure also relates to porous crosslinked hydrophilic polymeric materials prepared by such processes.

### BACKGROUND

In the manufacture of absorbent materials and structures for use in superabsorbent products and agricultural applications, there is a continual effort to improve performance characteristics. Porous crosslinked hydrophilic polymeric materials, for example, are useful in a variety of applications. Due to their abilities to absorb and retain water or aqueous fluids, they can be used in personal care products, biomedical applications, heavy metal binding, concrete curing, cable waterproof wrapping, horticulture and agriculture, as well as smart devices such as controlled release vehicles and sensors.

High internal phase emulsion, or HIPE, has been used in the preparation of a variety of porous crosslinked polymeric materials, including hydrophobic and hydrophilic ones. Normally, hydrophobic porous crosslinked polymeric materials are produced from water-in-oil HIPEs wherein the oil phase is the continuous external phase and the water or aqueous phase is the internal phase. Hydrophobic polymer precursors, namely monomers, and crosslinking agents are typically present in the oil external phase. The water or aqueous solution acts as a porogen, which occupies the internal space of the emulsion (an emulsion generally being a dispersion of one liquid in another liquid) during the crosslinking process and, upon removal, leaves pores in the crosslinked polymer matrix.

Similarly, hydrophilic porous crosslinked polymeric materials are usually produced from oil-in-water HIPEs wherein the aqueous phase containing hydrophilic polymer precursors, namely monomers, and crosslinking agent is the continuous external phase and the oil phase is the pore-generating internal phase. After crosslinking, typically, a block of porous crosslinked polymeric material having the shape of the container is produced. Porous crosslinked polymeric materials prepared from HIPEs can also be in other forms. For example, spherical or ellipsoidal beads can be produced by dispersing the HIPE in a suitable suspension medium and having the crosslinking process take place in the suspension containing the HIPE droplets. Continuous production such as extrusion of the HIPEs through a die may yield sheets or strips.

High internal phase emulsion polymers (polyHIPE's), such as those described in U.S. Pat. No. 5,331,015, have been developed in an effort to create absorbent polymeric foams with enhanced fluid intake. These polyHIPE's are typically prepared by polymerizing water-in-oil emulsions having a relatively small amount of an oil phase and a relatively greater amount of a water phase. The polymerized monomers and di-vinylated crosslinkers were pre-contained in an oil phase, and a hydrophobic polymer was formed after polymerization. Additionally, inverse HIPE polymer foams have been developed using oil-in-water (O/W) emulsion systems, wherein a water-soluble monomer and di-vinylated crosslinker were dissolved in a water-phase to form an oil-in-water emulsion. After polymerization, a hydrophilic polymer was obtained. Both of these polymers were manufactured by polymerization reactions.

U.S. Pat. No. 4,522,953 discloses hydrophobic porous crosslinked polymeric block materials prepared from water-in-oil HIPEs by polymerizing the monomers and crosslinker in the oil continuous phase of the HIPEs. The porous structure and hydrophobicity make the disclosed material especially suitable for uses as oil absorbents. U.S. Pat. No. 5,583,162 discloses hydrophobic porous crosslinked polymeric microbeads prepared by dispersing water-in-oil HIPE droplets in an aqueous suspension medium and polymerizing the monomers and crosslinker in the oil phase of the HIPE droplets.

After the preparation, porous crosslinked hydrophobic polymeric materials can be modified to become hydrophilic by means of functionalization. U.S. Pat. No. 4,536,521 describes a sulfonated crosslinked polymeric material capable of absorbing large volumes of ionic solutions prepared by polymerizing vinyl monomers in a water-in-oil HIPE. Functionalization of hydrophobic porous crosslinked polymeric microbeads prepared from water-in-oil HIPE droplets for absorption of aqueous solutions using amine salts, quaternary ammonium groups, alkoxylate groups, and sulfonate groups are disclosed in U.S. Pat. No. 5,583,162.

Porous crosslinked hydrophilic polymeric materials prepared from oil-in-water HIPEs by polymerizing hydrophilic monomers and crosslinker in the aqueous phase of the HIPEs are disclosed in U.S. Pat. No. 6,048,908. Porous crosslinked hydrophilic polymeric materials in the form of both blocks and microbeads are disclosed.

U.S. Pat. No. 5,149,720 describes a continuous process for preparing water-in-oil HIPEs, containing water-insoluble monofunctional monomers and a polyfunctional crosslinking agent in the oil phase of the HIPEs, which upon polymerization and dewatering, provide polymeric foam materials. An improved continuous process is disclosed in U.S. Pat. No. 5,827,909. Continuous production for producing porous crosslinked polymeric materials by polymerization of water-in-oil HIPEs have also been disclosed in U.S. Pat. Nos. 6,274,638 and 6,365,642.

### SUMMARY

Crosslinked polymeric materials are able to absorb solvents or solutions with like characteristics and expand in volume, i.e., swell without dissolving in the solvent. Both the solvent-free and swollen crosslinked polymeric materials may be useful in a variety of different applications. The extent to which swelling occurs depends on the characteristics of the solution and those of the polymeric network including the chemical characteristics of the backbone polymers and the degree of crosslinking. The absorption capabilities of a non-swelling porous polymeric material, such as cotton balls, is mainly attributed to the capillary force due to the existence of fine voids in the material structure. In crosslinked polymeric materials comprising a swellable crosslinked polymer matrix and fine voids or pores inside the matrix, two different mechanisms may come into play: the expansion of the crosslinked polymer matrix and the uptake of fluid by the pores. These mechanisms may contribute to the overall absorption and retention behavior of the materials. The absorbency of porous crosslinked polymeric materials thus depends on the characteristics of the polymer matrix and that of the pore structure. The internal phase of a HIPE occupies a relatively high percentage of space, generally greater than 70%, in the HIPE. After the crosslinking process, upon removal, the internal phase leaves voids or pores in the crosslinked polymer matrix. With careful control over the ratio and the interface between the internal and external phases, interconnected pores can be produced. The interconnected fine pores provide channels for fluid uptake and transport within the material, thereby facilitating the absorption.

In a broad aspect and in an embodiment of a process of the present disclosure, the preparation of a porous crosslinked hydrophilic polymeric material comprises the steps of: i) forming an oil-in-water high internal phase emulsion (HIPE) from an aqueous phase and an oil phase with the volume ratio between the oil phase and the aqueous phase being in the range of from about 70:30 to about 99:1; ii) crosslinking the oil-in-water HIPE by causing the active components in the aqueous phase of the HIPE to react; iii) removing the oil phase to obtain a highly porous crosslinked hydrophilic polymeric material; iv) optionally, post-treating the porous crosslinked hydrophilic polymeric material; and v) optionally, drying the porous crosslinked hydrophilic polymeric material.

The aqueous phase comprises: a) components for the formation of a crosslinked polymer network comprising at least one hydrophilic polymer, at least one crosslinker capable of reacting or interacting with the hydrophilic polymer, and, optionally, a water-soluble catalyst for the crosslinking reaction between the crosslinker and the hydrophilic polymer; b) optionally, an emulsion surfactant; and c) optionally, ingredients that are added to confer desired characteristics during processing or properties of the final product.

The aqueous phase may optionally further comprise an additional group of components for the formation of a second crosslinked polymer network comprising at least one water-soluble monofunctional ethylenically unsaturated monomer, at least one water-soluble polyfunctional ethylenically unsaturated crosslinking monomer, a free radical initiator, and, optionally, a reducing agent or catalyst (or, at least one of a reducing agent and catalyst).

The oil phase comprises: a) an oil that is immiscible with the aqueous phase; and b) optionally, ingredients that are added to confer desired characteristics during processing or properties of the final product.

The present disclosure discloses, among other things, a method for preparing porous crosslinked hydrophilic polymeric materials from oil-in-water HIPEs by directly crosslinking hydrophilic polymers in the aqueous phase of the HIPEs. The method of the present disclosure advantageously eliminates the need for a post-modification step to turn a crosslinked hydrophobic polymeric material into a hydrophilic one, though post-modification steps can be added for modifications of the product if desired. By directly producing a crosslinked hydrophilic polymeric material from the hydrophilic polymer, greater control over the characteristics of the backbone polymers of the crosslinked hydrophilic polymer network is obtained. Characteristics such as molecular weight and distribution, type and content of functional groups are easily varied as they have been controlled in the production step of the hydrophilic polymers. Furthermore, copolymers of well-defined characteristics and blends of different polymers can be easily incorporated into the crosslinked network by the method of the present disclosure in contrast to the method starting with monomers.

The present disclosure discloses, among other things, compositions and methods of making porous polymeric absorbent materials directly using a water soluble polymer and crosslinking the polymer with a crosslinker that reacts or interacts with certain functional groups on the polymer chain. In one embodiment, the present disclosure further comprises a cost-effective method for making a porous matrix capable of being mass produced. In one embodiment of the disclosure, the present method permits easy purification of the final crosslinked polymeric matrix without encountering problems during extractions.

In further embodiments, the process may comprise a method of making polymeric absorbent materials comprising: a) combining a water phase and an oil phase, the water phase comprising effective amounts of one hydrophilic polymer; and b) combining a crosslinker in water phase, whereby the water phase and the oil phase form an emulsion as a result of mechanical through agitation, such that cross-linking takes place in the water phase to form a porous material. The water phase may contain, for example: an uncrosslinked hydrophilic polymer and a crosslinker; a water soluble polymer and a crosslinker; and/or a catalyst. Crosslinking the polymer material (generally, creating the conditions that cause components to react and form crosslinks) can involve use of a chemical crosslinker, and can also comprise applying energy in the form of at least one of radiation such as electron beam, X-ray, gamma ray and ultraviolet light, ultrasound, and elevated temperature. The hydrophilic polymer may be polyvinyl alcohol. The hydrophilic polymer may be polyvinyl alcohol with a chemical functional group (generally, a group of atoms within molecules that have characteristic properties) in addition to the hydroxyl group, such as a chemical hydrophilic functional group or a chemical hydrophobic functional group.

### BRIEF DESCRIPTION OF THE DRAWINGS

FIG. 1 is flow diagram illustrating a basic process for producing porous crosslinked hydrophilic polymeric materials having enhanced absorption rates and retention properties; and

FIG. 2. is an image, taken with a scanning electron microscope, showing an illustrative porous crosslinked hydrophilic polymer product.

### DETAILED DESCRIPTION

### A. DEFINITIONS

The following definitions are offered relative to the present disclosure.

“Oil-in-water high internal phase emulsions or HIPEs” as used herein refers to high internal phase emulsions that contain equal or more than about 70% by volume of an oil phase as the internal phase and equal or less than about 30% by volume of an aqueous phase as the continuous external phase. (The aqueous phase, or water phase, refers to water or a solution in water of one or more substances.) Accordingly, an oil-in-water HIPE has volume ratios between the internal phase, i.e., the oil phase and the continuous external phase, i.e., the aqueous phase of equal to or greater than about 70:30. An “oil-in-water HIPE” should be distinguished from a “water-in-oil HIPE”, which has volume ratios between the oil phase (the continuous external phase) and the aqueous phase (the internal phase) of equal or less than about 30:70.

“About,” as used in the preceding paragraph with respect to amounts of any kind or with respect to relationships such as proportions, refers to the quantities that are close to or at the given numbers. In general, and as one skilled in the art ought to appreciate, it is not a strict limitation that any quantity be measured or defined or otherwise determined with absolute precision. Any quantity, whether prefaced with the word “about” or not, is not necessarily intended to be defined with total precision.

“Porous” as used herein refers to the crosslinked hydrophilic polymeric materials possess a structure where interconnected pores are present either in the dry state or after absorption of aqueous liquids. In the latter case, the pores can be occupied by a liquid.

“Crosslinking” as used herein refers to the process in which at least two polymer chains are linked together at each crosslink site and a three-dimensional network of polymers is formed as a result. It can be effected via copolymerization of monofunctional ethylonically unsaturated monomers and polyfunctional ethylonically unsaturated crosslinking monomers containing two or more polymerizable carbon-carbon double bonds, reactions between the functional groups of the crosslinker and the polymer, through ionic interactions between the crosslinker and the polymer, by free-radical processes, or energetic means. A crosslinked polymeric material typically has mechanical integrity and does not dissolve.

“Hydrophilic polymer” as used herein refers to a polymer that, when not crosslinked, is substantially soluble in water provided that sufficient amount of water, mechanical and thermal energy, and time are allowed for the dissolving process. As used herein, the term “hydrophilic polymer” refers to a polymer that is supplied in the polymer form prior to the process of the present disclosure, but not to a polymer that is formed as a result of polymerization of monomers during and after any of the process of the present disclosure.

Monofunctional ethylenically unsaturated monomer” as used herein refers to a monomer that has only one polymerizable carbon-carbon double bond in its structure. “Polyfunctional ethylenically unsaturated crosslinking monomer” as used herein refers to a monomer that has at least two polymerizable carbon-carbon double bonds in its structure

A porous crosslinked polymeric material obtained by “directly crosslinking” the hydrophilic polymers, as used herein, refers to a porous crosslinked polymeric material obtained as a result of the crosslinking process taking place between the hydrophilic polymers and the crosslinker capable of reacting or interacting with the functional groups in the hydrophilic polymer, without relying on the copolymerization of the monofunctional ethylenically unsaturated monomers and the polyfunctional ethylenically unsaturated crosslinking monomers. The latter may take place, but is not necessary for the formation of a crosslinked polymer network from the process of the present disclosure. The result of the optional copolymerization is merely adding another crosslinked polymer network in addition to the one formed by directly crosslinking the hydrophilic polymers.

An “interpenetrating polymer network (IPN)” as used herein refers to a polymer comprising two or more different kinds of interpenetrating backbone polymers that are independently crosslinked. Covalent linkages may or may not exist between polymers of different kind.

The term “network-forming polymers” as used herein refers to the sum of the hydrophilic polymer, and the optional polymeric constituent of the polymer network of the porous crosslinked hydrophilic polymeric material resulting from the optional copolymerization of the monofunctional ethylenically unsaturated monomer and the polyfunctional ethylenically unsaturated crosslinking monomer.

“Batch production” as used herein refers to a manufacturing technique (also called “batchwise”), in which the production is carried out in a container either without transferring the material to a different container throughout the manufacturing process or with the material being moved through a series of containers in which different stages of manufacturing take place. Products are produced by the batch.

“Continuous production” as used herein refers to a manufacturing technique, in which the production is carried out by preparing the material and having it flow through the production line continuously to effect different stages of manufacturing. Products are produced in a continuous fashion.

### B. COMPONENTS OF THE OIL-IN-WATER HIPE

The oil-in-water HIPE of the present disclosure includes a continuous external aqueous phase and an internal oil phase with the volume ratio between oil phase and aqueous phase equal to or greater than about 70:30. The continuous external aqueous phase contains at least one hydrophilic polymer, at least one crosslinker, optionally a catalyst for the crosslinking reaction, optionally a second group of network-forming components which include at least one water-soluble monofunctional ethylenically unsaturated monomer, at least one water-soluble polyfunctional ethylenically unsaturated crosslinking monomer, a free radical initiator, and optionally a reducing agent or catalyst, and optionally an emulsion surfactant. The oil phase comprises an oil immiscible with the aqueous phase. Both the aqueous and the oil phases may optionally contain other ingredients to confer desired characteristics during processing or properties of the final product.

1. Components of the Aqueous Phase

The continuous aqueous phase of the oil-in-water HIPE contains at least one hydrophilic polymer. The hydrophilic polymer contains sufficient amount of polar, charged or ionizable functional groups that render them soluble in water. Exemplary (that is, offered by way of example or illustration, and not necessarily put forth as preferred or especially advantageous) polar, charged or ionizable functional groups include but are not limited to hydroxyl group, carboxylic acid group and carboxylate salts, sulfonic acid group and sulfonate salts, phosphoric acid group and phosphonate salts, and amine group. The hydrophilic polymer must be crosslinkable so that a three-dimensional network can be formed after the crosslinking process. Exemplary hydrophilic polymers include but are not limited to synthetic polymers such as poly(vinyl alcohol) (PVOH) with various degrees of hydrolysis, poly(2-hydroxyethyl acrylate) (PHEA), poly(2-hydroxyethyl methacrylate) (PHEMA), poly(acrylic acid) (PAA) or salts thereof, polyacrylamide (PAAm), poly(itaconic acid) (PIA) or salts thereof, and polyethylene glycol (PEG), natural polymers thereof such as carboxymethyl cellulose, hydroxypropyl cellulose, cellulose sulfates, hyaluronic acid or salts thereof, humic acid or salts thereof, xanthan gum, starch, carrageenan, alginate, pectin, chitosan, denatured proteins, gelatin, and lignin sulfonates, and copolymers and modified derivatives thereof. Preferred hydrophilic polymers include poly(vinyl alcohol) (PVOH) with various degrees of hydrolysis, polyvinyl alcohol (PVOH) copolymers containing carboxylic acid and/or carboxylate salt groups, polyvinyl alcohol (PVOH) copolymers containing sulfonic acid and/or sulfonate salt groups, carboxylated polyvinyl alcohol (PVOH) derivatives, sulfonated polyvinyl alcohol (PVOH) derivatives, poly(2-hydroxyethyl acrylate) (PHEA), poly(2-hydroxyethyl methacrylate) (HEMA), poly(acrylic acid) (PAA) or salts thereof, polyethylene glycol (PEG), carboxymethyl cellulose, hydroxypropyl cellulose, cellulose sulfates, hyaluronic acid or salts thereof, humic acid or salts thereof, starch, lignin sulfonates, and copolymers and modified derivatives thereof. The continuous aqueous phase of the oil-in-water HIPE may also contain appropriate blends of hydrophilic polymers. The hydrophilic polymer is present in the continuous aqueous phase of the present disclosure in an amount of from about 33% to about 100% by weight, based on the total network-forming polymers in the aqueous phase.

The continuous aqueous phase of the oil-in-water HIPE also contains at least one crosslinker. The crosslinker is capable or reacting or interacting with at least two function groups, each being on a separate chain of the hydrophilic polymer, under suitable conditions so as to cause the formation of a three dimensionally crosslinked polymer network. The crosslinker may be a small molecule, an oligomer, a polymer, or any other suitable substrate that can be dissolved or suspended in the aqueous phase of the oil-in-water HIPE. Exemplary suitable crosslinkers for crosslinking the hydrophilic polymer through hydroxyl groups include but are not limited to glyoxal, glutaraldehyde (GA), epichlorohydrin (ECH), ethylene glycol diglycidyl ether (EGDGE), poly(ethylene glycol) diglycidyl ether (PEGDGE), ethylenediaminetetraacetic dianhydride (EDTAD), boric acid, and sodium borate. Exemplary suitable crosslinkers for crosslinking of the hydrophilic polymer through carboxylic acid groups include but are not limited to epichlorohydrin (ECH), ethylene glycol diglycidyl ether (EGDGE), poly(ethylene glycol) diglycidyl ether (PEGDGE), and adipic acid dihydrazide. Exemplary suitable crosslinkers for crosslinking of the hydrophilic polymer through amine groups include but are not limited to glyoxal, glutaraldehyde (GA), epichlorohydrin (ECH), ethylene glycol diglycidyl ether (EGDGE), poly(ethylene glycol) diglycidyl ether (PEGDGE), and ethylenediaminetetraacetic dianhydride (EDTAD). Other types of crosslinker such as nano- or micro-sized clay particles with suitable functional groups on the surface of the material may also be employed. Ionic crosslinkers that crosslink through ionic interactions may also be employed. Mixtures of crosslinkers can be employed. The crosslinker is present in the continuous aqueous phase of the present disclosure in an amount of from about 0.1% to about 50%, preferably from about 0.2% to about 40%, by weight, based on the total hydrophilic polymer in the aqueous phase. The amount of crosslinker generally does not exceed 50% by weight based on the total hydrophilic polymer in the aqueous phase.

Optionally, the continuous aqueous phase of the oil-in-water HIPE contains a water-soluble catalyst for the crosslinking reaction between the crosslinker and the hydrophilic polymer. Such a catalyst is “for crosslinking” in that the catalyst promotes the chemical reaction that leads to crosslinking. Exemplary suitable catalysts for the crosslinking reaction between aldehyde groups in the crosslinker and hydroxyl functional groups in the hydrophilic polymer include but are not limited to citric acid, phosphoric acid and hydrochloric acid. In one embodiment, the catalyst used is citric acid. Other exemplary suitable catalysts for the crosslinking reaction between the crosslinker and the hydrophilic polymer include but are not limited to triethylamine, pyridine, sodium hydroxide, and potassium hydroxide. Mixtures of catalysts may be employed. The catalyst is present in the continuous aqueous phase of the present disclosure in an amount of from about 0% to about 5%, preferably from about 0.01% to about 3%, by weight, based on the total aqueous phase.

Optionally, the continuous aqueous phase of the oil-in-water HIPE may contain a second group of network-forming components which include at least one water-soluble monofunctional ethylenically unsaturated monomer, at least one water-soluble polyfunctional ethylenically unsaturated crosslinking monomer, a free radical initiator, and optionally a reducing agent or catalyst. Free radical copolymerization of the monofunctional ethylenically unsaturated monomer and the polyfunctional ethylenically unsaturated crosslinking monomer leads to the formation of a second crosslinked network. The second network, together with the first network comprising crosslinked hydrophilic polymer obtained by directly crosslinking the hydrophilic polymer dissolved in the aqueous phase of the oil-in-water HIPEs, form an interpenetrating polymer network (IPN).

Exemplary water-soluble monofunctional ethylenically unsaturated monomer include but are not limited to acrylic acid or salts thereof, methacrylic acid or salts thereof, itaconic acid or salts thereof, 2-Hydroxyethyl acrylate, 2-hydroxyethyl methacrylate, acrylamide, and N-isopropylacrylamide. Preferred monomers of this kind include acrylic acid or salts thereof. Mixtures of water-soluble monofunctional ethylenically unsaturated monomers may be employed. The monomer of the second group of network-forming components can be present in the continuous aqueous phase of the present disclosure in an amount of from about 0% to about 67% by weight, based on the total network-forming polymers in the aqueous phase.

Exemplary suitable water-soluble polyfunctional ethylenically unsaturated crosslinking monomer include but are not limited to N,N′-Methylenebis(acrylamide) (MBA), ethylene glycol diacrylate (EGDA), poly(ethylene glycol) diacrylate (PEGDA), ethylene glycol dimethacrylate (EGDMA), poly(ethylene glycol) dimethacrylate (PEGDMA), and other such crosslinking monomers known to those skilled in the art. The water-soluble polyfunctional ethylenically unsaturated crosslinking monomer is present in the continuous aqueous phase of the present disclosure in an amount of from about 0.1% to about 20%, preferably from about 0.5% to about 15%, by weight, based on the total water-soluble monofunctional ethylenically unsaturated monomer in the aqueous phase.

Exemplary free radical initiators suitable for initiating free radical copolymerizations in aqueous solution include but are not limited to potassium persulfate, sodium persulfate, ammonium persulfate, hydrogen peroxide, and other such initiators known to those skilled in the art. The free radical initiator may be used together with a reducing agent or catalyst as a free radical initiation system. Exemplary suitable reducing agents or catalysts include but are not limited to sodium bisulfite, ammonium bisulfite, tetramethylethylenediamine (TMEDA), ferrous sulfate, and other such reducing agents or catalysts known to those skilled in the art. The free radical initiator is present in the continuous aqueous phase of the present disclosure in an amount of from about 0.05% to about 10%, preferably from about 0.1% to about 5%, by weight, based on the total water-soluble monofunctional ethylenically unsaturated monomer in the aqueous phase. The optional reducing agent or catalyst is present in the continuous aqueous phase of the present disclosure in an amount of from about 0 to about 200%, preferably from about 0% to about 100%, by weight, based on the total free radical initiator in the aqueous phase.

The continuous aqueous phase of the oil-in-water HIPE may contain an emulsion surfactant. Suitable emulsion surfactants have high hydrophilic-lipophilic balance (HLB) values (>10), are soluble in the aqueous phase and are capable of forming stable oil-in-water HIPEs. Exemplary suitable emulsion surfactants include but are not limited to polyoxyethylene isooctylphenyl ethers with different lengths of the ethylene oxide chain (Triton™ X series) such as Triton™ X-305 (n=30, HLB=17.3), Triton™ X-405 (n=35, HLB=17.6), and Triton™ X-705 (n=55, HLB=18.4), and polyoxyethylene sorbitan fatty acid esters with different lengths of the aliphatic chain of the fatty acid (TWEEN® series) such as polyoxyethylene sorbitan monostearate (TWEEN® 60, HLB=14.9), polyoxyethylene sorbitan monooleate (TWEEN® 80, HLB=15.0), polyoxyethylene sorbitan monopalmitate (TWEEN® 40, HLB=15.6), and polyoxyethylene sorbitan monolaurate (TWEEN® 20, HLB=16.7). A preferred emulsion surfactant is Triton™ X-405. Mixtures of emulsion surfactants may be employed. It is possible that one or more of the hydrophilic polymer components in the continuous aqueous phase function as an emulsion surfactant and no additional emulsion surfactant is necessary. The emulsion surfactant is present in the continuous aqueous phase of the present disclosure in an amount of from about 0% to about 15%, preferably from about 2% to about 10%, by weight, based on the total aqueous phase.

Additional optional ingredients may be added to the aqueous phase to confer desired characteristics during processing or properties of the final product. Exemplary optional ingredients include but are not limited to the ones that can adjust solubility of the emulsion components, viscosity modifiers, antioxidants, dyes and pigments, fluorescers, fillers, fibers, odor absorbents, and other polymer additives.

2. Oil Phase

The internal oil phase of the oil-in-water HIPE comprises at least one oil that is immiscible with the aqueous phase. The oil is a porogen that upon removal leaves pores in the crosslinked hydrophilic polymeric material. A suitable class of oil is hydrophobic organic solvent. Such hydrophobic organic solvents include but are not limited to aromatic hydrocarbons such as benzene, toluene, and xylene, alkanes such as hexane, heptane, octane, nonane, decane, undecane, dodecane, pentadecane, and hexadecane, mineral oil, silicone oil, and dichloromethane. Preferred hydrophobic organic solvents include toluene and dodecane. Another suitable class of oil is vegetable oil. Such vegetable oils include but are not limited to soybean oil, corn oil, canola oil, sunflower oil, cottonseed oil, peanut oil, and the like. Mixtures of oils may be employed. Generally, the oil phase is present in the oil-in-water HIPE of the present disclosure in an amount of from about 70% to about 99% by volume, based on the total oil-in-water HIPE.

Additional optional ingredients may be added to the oil phase to confer desired characteristics during processing or properties of the final product. Exemplary optional ingredients include but are not limited to the ones that can adjust solubility of the emulsion components, and viscosity modifiers.

### C. PREPARATION OF POROUS CROSSLINKED HYDROPHILIC POLYMERIC MATERIALS FROM OIL-IN-WATER HIPES

1. Formation of the HIPE

Generally, an oil-in-water HIPE is formed by preparing an aqueous phase and an oil phase, combining the two, and subjecting the mixture to agitation that provides the shear force needed for the formation of the HIPE. The volume percentage of the oil phase in the oil-in-water HIPE formed essentially determines the pore volume fraction in the porous crosslinked hydrophilic polymeric material. A preferred emulsification temperature for the formation of emulsion is from about 20° C. to about 60° C. A higher temperature may be used for dissolving hydrophilic polymers in the aqueous solution. The temperature of the aqueous phase may then be brought down to one preferred for the formation of emulsion. Agitation is applied to an extent and for a time period suitable for the formation of a stable emulsion with the desired sizes of oil droplets. The HIPE should remain stable for a time period sufficient for the subsequent crosslinking process to occur. The formation of HIPE can be conducted either batch wise or in a continuous fashion.

2. Crosslinking of the HIPE

Porous crosslinked hydrophilic polymeric materials are produced from a HIPE by directly crosslinking the hydrophilic polymer dissolved in the aqueous continuous phase of the oil-in-water HIPE. Heat is usually used to convert the oil-in-water HIPE to a crosslinked hydrophilic polymeric material with oil droplets distributed throughout the polymer matrix, resembling the HIPE structure before crosslinking. Suitable crosslinking temperature ranges from about 20° C. to about 80° C., preferably from about 40° C. to about 60° C. A catalyst may be used to promote the crosslinking reaction. The time needed to yield a porous crosslinked hydrophilic polymeric material depends on the rate of crosslinking reaction which may be controlled by the crosslinking temperature, as well as the type and concentration of crosslinker and those of the catalyst if one is used. Generally, methods to shorten or lengthen the time needed for the crosslinking reaction by adjusting the above-mentioned factors are known to one skilled in the art. Other methods, such as energetic or physical means, of crosslinking may be applied. The crosslinking process may be carried out either in a batch or a continuous fashion. The degree of crosslinking can generally be controlled by varying the level of crosslinker used, and would be indicated by the extent of swelling in a good solvent and mechanical strength of the porous crosslinked hydrophilic polymeric materials.

3. Removal of Oil Phase

After the crosslinking process, the oil phase needs to be removed to obtain the porous crosslinked hydrophilic polymeric materials. Upon removal of the oil phase, interconnected pores are left behind in the crosslinked polymer structure. These pores are accessible and available to be occupied by a suitable fluid, which permits the fluid uptake, transfer and retention by the porous crosslinked hydrophilic polymeric materials.

The oil phase can be removed by a variety of techniques. In one embodiment, suitable organic solvents, such as acetone or methanol, is used to extract the oil phase from the porous crosslinked hydrophilic polymeric material after the crosslinking process. Stirring is provided to facilitate the extraction process. Multiple cycles of washing can be carried out with the washing solvent being refreshed after each washing cycle. The emulsion surfactant, and any other uncrosslinked emulsion components are substantially removed from the porous crosslinked hydrophilic polymeric material during this step. Depending on the characteristics of the washing solvent, a portion of water is removed as well from the porous crosslinked hydrophilic polymeric material.

In another embodiment, the removal of oil phase, i.e., the washing process is carried out using an aqueous solution. The aqueous solution may contain a base, a carbonate, a bicarbonate, or mixtures (combinations) thereof.

In another embodiment, where a vegetable oil is used as the internal oil phase of the oil-in-water HIPE, a dish detergent solution (including a commercially available detergent ordinarily applied to clean household goods) is used for the removal of oil phase, i.e., the washing process.

The product is often cut, ground, or otherwise comminuted, in order to facilitate the removal of oil phase, i.e., washing.

Optionally, the porous crosslinked hydrophilic polymeric materials obtained after the crosslinking process can be further modified to confer desired physical or chemical properties. For example, the material may be treated with a base, a carbonate, a bicarbonate, or mixtures thereof, dissolved in an aqueous solution. In some cases, the post-treatment with a base, a carbonate, a bicarbonate, or mixtures thereof may be combined into the washing step. Another exemplary post treatment may involve functionalization of the porous crosslinked hydrophilic polymeric materials, such as sulfonation.

After the removal of oil phase, the porous crosslinked hydrophilic polymeric materials may be further subjected to a dewatering, i.e., drying process. Dewatering can be carried out by methods such as air drying, drying in a conventional, convection or vacuum oven, solvent exchange, freeze drying and any other methods or combination of methods that are suitable for removing water or moisture from the porous crosslinked hydrophilic polymeric materials.

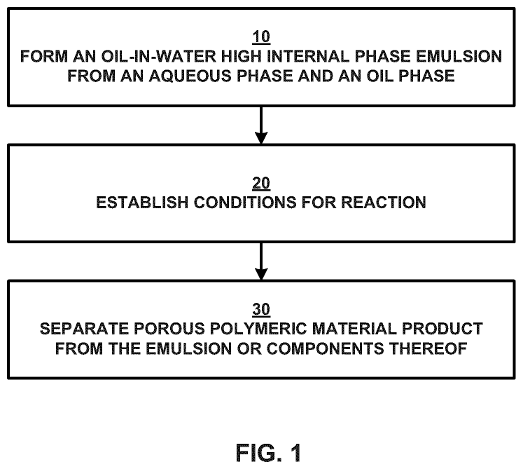

FIG. 1 summarizes some of the techniques described herein. There are many variations and optional steps that are not included in FIG. 1, which is set out as an example. An emulsion is formed from an oil phase and an aqueous phase; the emulsion is an oil-in-water high phase internal phase emulsion (10). The volume ratio between the oil phase and the aqueous phase is in the range of from about 70:30 to about 99:1. This stage (10) may include any several preparatory stages or sub-stages.

For example, the water phase or aqueous phase may be prepared, such as by including in the aqueous phase components for the formation of a first crosslinked polymer network. Such components may include: from 33% to 100% by weight, based on the total network-forming polymers, of at least one hydrophilic polymer; and from 0.1% to 50% by weight, based on the total hydrophilic polymer, of at least one crosslinker capable of reacting or interacting with the hydrophilic polymer. The water phase may comprise effective amounts of one hydrophilic polymer. Examples of hydrophilic polymers include polyvinyl alcohol, polyacrylic acid, polymethacrylic acid, polymaleic acid, and salts thereof. In some implementations, a catalyst (such as a water-soluble catalyst for the crosslinking reaction between the crosslinker and the hydrophilic polymer) may be included. Optionally, components for the formation of a second crosslinked polymer network may also be included, such as components comprising: from about 0% to about 67% by weight, based on the total network-forming polymers, of at least one water-soluble monofunctional ethylenically unsaturated monomer; from about 0.1% to about 20% by weight, based on the total monofunctional ethylenically unsaturated monomer, of at least one water-soluble polyfunctional ethylenically unsaturated crosslinking monomer; from about 0.05% to about 10% by weight, based on the total monofunctional ethylenically unsaturated monomer, of a free radical initiator; and optionally, from about 0% to about 200% by weight, based on the total free radical initiator, of a reducing agent or catalyst. Optionally, a surfactant may be included, such as from about 0% to about 15% by weight, based on the total aqueous phase, of an emulsion surfactant.

Further, and optionally, ingredients may be added to confer desired characteristics during processing or properties of the final product. The ingredients depend upon the final product and the characteristics desired.

There is no particular method or apparatus for preparation of the water phase; many techniques for doing so are known in the art.

The oil phase may be prepared as well. In addition to having an oil that is immiscible with the aqueous phase, the oil phase may optionally include ingredients that are added to confer desired characteristics during processing or properties of the final product. There is no particular method or apparatus for preparation of the oil phase; many techniques for doing so are known in the art.

This discussion is for illustration and not intended to indicate that certain steps must be performed in a particular order. It may be possible, for example, to add ingredients to the emulsion rather than to the individual phases prior to creation of the emulsion. The creation or formation of the emulsion may involve agitation and/or temperature control.

After the creation or formation of the emulsion, conditions may then be established to enable or promote or hasten or otherwise effect the reaction (20). Such conditions may include isolation, temperature control (e.g., heating or maintaining at room temperature), agitation, actions or agents that may promote crosslinking, such as application of radiation such as electron beam, X-ray, gamma ray and ultraviolet light, and ultrasound. Such conditions may be constant, time-varying, intermittent, applied at particular times or in response to particular conditions, and so forth. Depending upon the chemicals involved and the conditions and the product, the time between creation of the emulsion (10) and the recovery of the finished porous polymeric material product (30) may be brief (e.g., a matter of seconds) or long (e.g., a matter of several hours). Activities such as these bring about crosslinking the oil-in-water HIPE by causing the active components in the aqueous phase of the HIPE to react.

The reaction produces the porous crosslinked hydrophilic polymeric material product, and the oil or internal phase is removed from the HIPE after the crosslinking process, leaving behind the porous crosslinked hydrophilic polymeric material (30). This may include physically removing the product from the location or the apparatus where the chemical reaction took place. This may also include various procedures such as those described herein, such as washing and drying the product, and any of several optional post-treatments, such as treatment with a base, treatment with a carbonate, treatment with a bicarbonate and mixtures thereof.

There is no set value or range for an “effective amount”; what makes an amount “effective” depends upon the polymer and the desired chemical reactions and the desired product. One skilled in the art would understand that an effective amount may be thought of as an amount that is sufficient to effect (that is, chemically to cause to happen) the reactions that generate the resultant product. In the examples herein, any particular effective amount that was specified is not necessarily the only effective amount, and the concepts are not necessarily restricted to the particular values disclosed.

### D. TEST METHODS

Absorbency: Absorbency of a solvent or solution is the quantity of solvent or solution that can be absorbed and retained by the porous crosslinked hydrophilic polymeric material. It is a relative measure of the pore structure and the degree of crosslinking of the porous crosslinked hydrophilic polymeric material. It is also an indication of the performance of the material as a device to absorb and retain water or other aqueous fluids. Dry material was used in the absorbency test. The test was conducted at room temperature.

The absorbency is measured according to the following method. An empty tea bag and the dry sample were weighed independently using an analytical balance (0.0001 g). The weight of the empty tea bag (W1) and that of the dry sample (W2) were recorded. The dry sample was placed in the tea bag and subsequently placed in a container with adequate amount of distilled water and allowed the equilibrium (no further weight change) to be reached. The tea bag containing the sample, after the equilibrium is reached, is drained and the excess free water is removed from the surface of the tea bag by using paper towels. The weight of the wet tea bag containing the sample (W3) was then measured (0.0001 g) and recorded. The absorbency was calculated as follows.

Absorbency=(W3−W1−W2)/W2

### E. SPECIFIC EXAMPLES

These nonlimiting examples illustrate the preparation of porous crosslinked hydrophilic polymeric materials from oil-in-water HIPEs according to the present disclosure. Variations will be recognized by those skilled in the art so as to produce porous crosslinked hydrophilic polymeric materials from oil-in-water HIPEs with desired properties for the end application.

### Example 1

A porous crosslinked hydrophilic polymeric material was prepared from an oil-in-water HIPE comprising a continuous aqueous phase containing a polyvinyl alcohol (PVOH) copolymer (Elvanol™ 80-18), glutaraldehyde (GA), citric acid, and a polyoxyethylene isooctylphenyl ether (Triton™ X-405, The Dow Chemical Company), and an oil phase comprising toluene. The components and amounts used are summarized in Table 1. The continuous aqueous phase was prepared by dissolving the PVOH copolymer in water in a 500 mL beaker at 90° C., cooling the solution to 45° C., and mixing the solution with citric acid, glutaraldehyde solution, and Triton™ X-405 solution (70% in water) at 45° C. After mixing, toluene was combined with the mixture which was then subjected to shear agitation using a high-speed homogenizer (Greerco homogenizer, National Oilwell Varco, L.P., Dayton, Ohio) to obtain an oil-in-water HIPE. The HIPE was heated at 45° C. for about 20 hours to effect the crosslinking reaction between the PVOH copolymer and GA, catalyzed by citric acid.

TABLE 1

| Components of the HIPE | Amount | |
|---|---|---|
| PVOH copolymer (Elvanol ™ | 13.0 | g |
| 80-18) | | |
| Glutaraldehyde (50% in water) | 67.3 | μL |
| Citric acid | 1.842 | g |
| Water | 95.7 | mL |
| Triton ™ X-405 (70% in water) | 8.7 | mL |
| Toluene | 326 | mL |

The product was then removed from the beaker, cut into small pieces and washed with acetone. The washed product was treated with potassium hydroxide solution. The potassium hydroxide treated product was dried at 60° C. in a conventional oven and cooled to room temperature. The absorbency of the porous crosslinked hydrophilic polymeric material of distilled water was 252 g/g.

### Example 2

A porous crosslinked hydrophilic polymeric material was prepared following a similar general process, unless otherwise specified, as described in Example 1. The components and amounts are given in Table 2.

TABLE 2

| Components of the HIPE | Amount | |
|---|---|---|
| PVOH copolymer (Elvanol ™ | 13.0 | g |
| 80-18) | | |
| Glutaraldehyde (50% in water) | 134.5 | μL |
| Citric acid | 1.842 | g |
| Water | 95.7 | mL |
| Triton ™ X-405 (70% in water) | 8.7 | mL |
| Toluene | 326 | mL |

The product was washed with methanol. The washed product was treated with potassium hydroxide solution. The potassium hydroxide treated product was dried at 70° C. in a conventional oven and cooled to room temperature. The absorbency of the porous crosslinked hydrophilic polymeric material of distilled water was 106 g/g.

### Example 3

More exemplary porous crosslinked hydrophilic polymeric materials were prepared following the similar general processes, unless otherwise specified, as described in Example 1. The components and amounts are given in Tables 3 and 4.

TABLE 3

| Components of the HIPE | Amount |
|---|---|
| PVOH (POVAL ™ 5-88) | 22.5 g |
| Glutaraldehyde (50% in water) | 1.826 mL |
| Citric acid | 1.656 g |
| Water | 86.2 mL |
| Triton ™ X-405 (70% in water) | 7.25 mL |
| Toluene | 272 mL |

The product was washed with methanol. No treatment with potassium hydroxide solution was carried out. The washed product was dried at 70° C. in a conventional oven and cooled to room temperature. The absorbency of the porous crosslinked hydrophilic polymeric material of distilled water was 4 g/g.

TABLE 4

| Components of the HIPE | Amount | |
|---|---|---|
| PVOH (Elvanol ™ 90-50) | 13.0 | g |
| Glutaraldehyde (50% in water) | 134.5 | μL |
| Citric acid | 1.842 | g |
| Water | 95.7 | mL |
| Triton ™ X-405 (70% in water) | 8.7 | mL |
| Toluene | 326 | mL |

The product was washed with acetone. No treatment with potassium hydroxide solution was carried out. The washed product was dried at 40° C. in a conventional oven and cooled to room temperature. The absorbency of the porous crosslinked hydrophilic polymeric material of distilled water was 11 g/g.

### Example 4

A porous crosslinked hydrophilic polymeric material was prepared from an oil-in-water HIPE comprising a continuous aqueous phase containing a polyvinyl alcohol (PVOH) polymer (Elvanol™ 71-30), glutaraldehyde (GA), acrylic acid, N,N′-Methylenebis (acrylamide) (MBA), ammonium persulfate (APS), tetramethylethylenediamine (TMEDA), poly(acrylic acid) (PAA, average Mv ˜450,000), poly(tetrahydrofuran) (PTMEG, average Mn ˜650), and a polyoxyethylene isooctylphenyl ether (Triton™ X-405, The Dow Chemical Company), and an oil phase comprising toluene. The components and amounts used are summarized in Table 5. Two solutions were prepared separately and combined. One solution was prepared by dissolving acrylic acid, PAA, MBA, and dispersing PTMEG in a certain amount of water at room temperature. Due to the small scale of the present example, no substantial cooling was needed. Another solution was prepared by dissolving the PVOH polymer in a certain amount of water in a 500 mL beaker at 90° C., cooling the solution to 45° C. The two solutions were combined and mixed in the 500 mL beaker, and glutaraldehyde solution, APS, TMEDA, and Triton™ X-405 solution (70% in water) were added and mixed to the combined solution at 45° C. to prepare the continuous aqueous phase. Toluene was combined with the aqueous phase, and the mixture was then subjected to shear agitation using a high-speed homogenizer (Greerco homogenizer, National Oilwell Varco, L.P., Dayton, Ohio) to obtain an oil-in-water HIPE. The HIPE was heated at 45° C. for about 20 hours to effect the crosslinking reaction and copolymerization.

TABLE 5

| Components of the HIPE | Amount | |
|---|---|---|
| PVOH (Elvanol ™ 71-30), | 7.5 | g |
| dissolved in 43.2 mL water | | |
| Acrylic acid, | 15.0 | g |
| dissolved in 33 mL water | | |
| MBA | 0.075 | g |
| PAA (Mᵥ ~450,000) | 0.15 | g |
| PTMEG (Mₙ ~650) | 0.3 | g |
| APS, | 0.506 | g |
| dissolved in 10 mL water | | |
| TMEDA | 332.8 | μL |
| Glutaraldehyde (50% in water) | 77.1 | μL |
| Triton ™ X-405 (70% in water) | 7.25 | mL |
| Toluene | 272 | mL |

The product was then removed from the beaker, cut into small pieces and washed with methanol. The washed product was treated with potassium hydroxide solution. The potassium hydroxide treated product was dried at 60° C. in a conventional oven and cooled to room temperature. The absorbency of the porous crosslinked hydrophilic polymeric material of distilled water was 273 g/g.

### Example 5

More exemplary porous crosslinked hydrophilic polymeric materials were prepared following the similar general processes, unless otherwise specified, as described in Example 4. The components and amounts are given in Tables 6 to 15.

TABLE 6

| Components of the HIPE | Amount | |
|---|---|---|
| PVOH (POVAL ™ 5-88), | 7.5 | g |
| dissolved in 43.2 mL water | | |
| Acrylic acid, | 15.0 | g |
| dissolved in 33 mL water | | |
| MBA | 0.15 | g |
| PAA (Mᵥ ~450,000) | 0.15 | g |
| PTMEG (Mₙ ~650) | 0.3 | g |
| KPS, | 0.6 | g |
| dissolved in 10 mL water | | |
| TMEDA | 166.4 | μL |
| Glutaraldehyde (50% in water) | 154.2 | μL |
| Triton ™ X-405 (70% in water) | 7.25 | mL |
| Toluene | 272 | mL |

The HIPE was heated at 45° C. for about 6 hours to effect the crosslinking reaction and copolymerization. The product was washed with methanol. The potassium hydroxide treated product was dried at 70° C. in a conventional oven and cooled to room temperature. The absorbency of the porous crosslinked hydrophilic polymeric material of distilled water was 540 g/g.

TABLE 7

| Components of the HIPE | Amount | |
|---|---|---|
| PVOH (POVAL ™ 5-88), | 7.5 | g |
| dissolved in 43.2 mL water | | |
| Acrylic acid, | 15.0 | g |
| dissolved in 33 mL water | | |
| MBA | 0.075 | g |
| PAA (Mᵥ ~450,000) | 0.15 | g |
| PTMEG (Mₙ ~650) | 0.3 | g |
| APS, | 0.506 | g |
| dissolved in 10 mL water | | |
| TMEDA | 332.8 | μL |
| Glutaraldehyde (50% in water) | 77.1 | μL |
| Triton ™ X-405 (70% in water) | 7.25 | mL |
| Toluene | 272 | mL |

The HIPE was heated at 45° C. for about 8 hours to effect the crosslinking reaction and copolymerization. The product was washed with acetone. The potassium hydroxide treated product was dried at 70° C. in a conventional oven and cooled to room temperature. The absorbency of the porous crosslinked hydrophilic polymeric material of distilled water was 312 g/g.

TABLE 8

| Components of the HIPE | Amount | |
|---|---|---|
| PVOH (POVAL ™ 5-88), | 7.5 | g |
| dissolved in 43.2 mL water | | |
| Acrylic acid, | 15.0 | g |
| dissolved in 33 mL water | | |
| MBA | 0.0375 | g |
| PAA (Mᵥ ~450,000) | 0.15 | g |
| PTMEG (Mₙ ~650) | 0.3 | g |
| APS, | 0.506 | g |
| dissolved in 10 mL water | | |
| TMEDA | 332.8 | μL |
| Glutaraldehyde (50% in water) | 48.7 | μL |
| Triton ™ X-405 (70% in water) | 7.25 | mL |
| Toluene | 272 | mL |

The HIPE was heated at 45° C. for about 24 hours to effect the crosslinking reaction and copolymerization. The product was washed with methanol. The potassium hydroxide treated product was dried at 70° C. in a conventional oven and cooled to room temperature. The absorbency of the porous crosslinked hydrophilic polymeric material of distilled water was 373 g/g.

TABLE 9

| Components of the HIPE | Amount | |
|---|---|---|
| PVOH (Elvanol ™ 71-30), | 12.0 | g |
| dissolved in 54.6 mL water | | |
| Acrylic acid, | 12.0 | g |
| dissolved in 23 mL water | | |
| MBA | 0.06 | g |
| PAA (Mᵥ ~450,000) | 0.12 | g |
| PTMEG (Mₙ ~650) | 0.24 | g |
| APS, | 0.405 | g |
| dissolved in 4 mL water | | |
| TMEDA | 266.4 | μL |
| Glutaraldehyde (50% in water) | 123.8 | μL |
| Triton ™ X-405 (70% in water) | 8.5 | mL |
| Dodecane | 317 | mL |

The product was washed with acetone. The potassium hydroxide treated product was dried at 70° C. in a conventional oven and cooled to room temperature. The absorbency of the porous crosslinked hydrophilic polymeric material of distilled water was 109 g/g.

TABLE 10

| Components of the HIPE | Amount | |
|---|---|---|
| PVOH (Elvanol ™ 71-30), | 2.0 | g |
| dissolved in 21.3 mL water | | |
| Acrylic acid, | 18.0 | g |
| dissolved in 39.6 mL water | | |
| MBA | 0.09 | g |
| PAA (Mᵥ ~450,000) | 0.18 | g |
| PTMEG (Mₙ ~650) | 0.36 | g |
| APS, | 0.607 | g |
| dissolved in 5 mL water | | |
| TMEDA | 399.4 | μL |
| Glutaraldehyde (50% in water), | 20.6 | μL |
| dissolved in 5 mL water | | |
| Triton ™ X-405 (70% in water) | 7.3 | mL |
| Toluene | 273 | mL |

The product was washed with acetone. The potassium hydroxide treated product was dried at 70° C. in a conventional oven and cooled to room temperature. The absorbency of the porous crosslinked hydrophilic polymeric material of distilled water was 356 g/g.

TABLE 11

| Components of the HIPE | Amount | |
|---|---|---|
| PVOH (Elvanol ™ 71-30), | 12.0 | g |
| dissolved in 54.6 mL water | | |
| Acrylic acid, | 12.0 | g |
| dissolved in 23 mL water | | |
| MBA | 0.036 | g |
| PAA (Mᵥ ~450,000) | 0.12 | g |
| PTMEG (Mₙ ~650) | 0.24 | g |
| APS, | 0.405 | g |
| dissolved in 4 mL water | | |
| TMEDA | 266.4 | μL |
| Glutaraldehyde (50% in water) | 61.9 | μL |
| Triton ™ X-405 (70% in water) | 8.5 | mL |
| Dodecane | 317 | mL |

The product was washed with acetone. The potassium hydroxide treated product was dried at 70° C. in a conventional oven and cooled to room temperature. The absorbency of the porous crosslinked hydrophilic polymeric material of distilled water was 65 g/g.

TABLE 12

| Components of the HIPE | Amount | |
|---|---|---|
| PVOH copolymer (Elvanol ™ | 16.8 | g |
| 80-18), | | |
| dissolved in 59.6 mL water | | |
| Acrylic acid, | 7.2 | g |
| dissolved in 18 mL water | | |
| MBA | 0.036 | g |
| PAA (Mᵥ ~450,000) | 0.072 | g |
| PTMEG (Mₙ ~650) | 0.144 | g |
| APS, | 0.243 | g |
| dissolved in 4 mL water | | |
| TMEDA | 159.8 | μL |
| Glutaraldehyde (50% in water) | 173.3 | μL |
| Triton ™ X-405 (70% in water) | 8.5 | mL |
| Toluene | 317 | mL |

The product was washed with methanol. The potassium hydroxide treated product was dried at 60° C. in a conventional oven and cooled to room temperature. The absorbency of the porous crosslinked hydrophilic polymeric material of distilled water was 126 g/g.

TABLE 13

| Components of the HIPE | Amount | |
|---|---|---|
| PVOH copolymer (Elvanol ™ | 12.0 | g |
| 80-18), | | |
| dissolved in 54.6 mL water | | |
| Acrylic acid, | 12.0 | g |
| dissolved in 23 mL water | | |
| MBA | 0.06 | g |
| PAA (Mᵥ ~450,000) | 0.12 | g |
| PTMEG (Mₙ ~650) | 0.24 | g |
| APS, | 0.405 | g |
| dissolved in 4 mL water | | |
| TMEDA | 266.4 | μL |
| Glutaraldehyde (50% in water) | 123.8 | μL |
| Triton ™ X-405 (70% in water) | 8.5 | mL |
| Toluene | 317 | mL |

The product was washed with acetone. The potassium hydroxide treated product was dried at 60° C. in a conventional oven and cooled to room temperature. The absorbency of the porous crosslinked hydrophilic polymeric material of distilled water was 138 g/g.

TABLE 14

| Components of the HIPE | Amount | |
|---|---|---|
| PVOH (Elvanol ™ 90-50), | 7.5 | g |
| dissolved in 43.2 mL water | | |
| Acrylic acid, | 15.0 | g |
| dissolved in 33 mL water | | |
| MBA | 0.075 | g |
| PAA (Mᵥ ~450,000) | 0.15 | g |
| PTMEG (Mₙ ~650) | 0.3 | g |
| APS, | 0.506 | g |
| dissolved in 10 mL water | | |
| TMEDA | 332.8 | μL |
| Glutaraldehyde (50% in water) | 77.1 | μL |
| Triton ™ X-405 (70% in water) | 7.25 | mL |
| Toluene | 272 | mL |

The product was washed with methanol. The potassium hydroxide treated product was dried at 60° C. in a conventional oven and cooled to room temperature. The absorbency of the porous crosslinked hydrophilic polymeric material of distilled water was 137 g/g.

TABLE 15

| Components of the HIPE | Amount | |
|---|---|---|
| PVOH copolymer (Elvanol ™ | 2.0 | g |
| 80-18), | | |
| dissolved in 54.6 mL water | | |
| Acrylic acid, | 12.0 | g |
| dissolved in 23 mL water | | |
| MBA | 0.09 | g |
| PAA (Mᵥ ~450,000) | 0.12 | g |
| PTMEG (Mₙ ~650) | 0.24 | g |
| APS, | 0.405 | g |
| dissolved in 4 mL water | | |
| TMEDA | 266.4 | μL |
| Glutaraldehyde (50% in water) | 99.0 | μL |
| Triton ™ X-405 (70% in water) | 8.5 | mL |
| Toluene | 317 | mL |

The product was washed with methanol. The potassium hydroxide treated product was dried at 60° C. in a conventional oven and cooled to room temperature. The absorbency of the porous crosslinked hydrophilic polymeric material of distilled water was 135 g/g.

### Further Examples

The present disclosure is further directed to polymeric absorbent composites having enhanced absorption rates and retention properties, and more particularly to a method of preparing a highly porous polyvinyl alcohol absorbent. The disclosure is also directed to a method of making absorbent composites, which may have enhanced absorption rates and retention properties, in comparison to some polymeric absorbent composites. The present disclosure is further directed to compositions comprising the absorbent composites.

In accordance with one embodiment of the present disclosure, absorbent polymeric foams can be manufactured by adding an organic phase to an aqueous phase containing a non-crosslinked linear polymer and a crosslinker, causing the crosslinking of the polymer to be carried out in the aqueous phase.

In a broad aspect, an absorbent foam can be made from combining an aqueous phase containing a linear polymer and an organic phase, and combining a crosslinker to the aqueous phase, causing polymerization of the polymer in the aqueous phase to form a porous material. The concepts can be illustrated by examples.

In one example and embodiment, an aqueous phase was prepared by mixing 20 mL of 20% (wt) polyvinyl alcohol (Mw: 13,000-23,000 Da, 98% hydrolyzed), 2 mL of hydrochloric acid (1.0 N), 0.5 mL of glutaraldehyde (50% aqueous solution), and 4 mL Triton X-405 (70% aqueous solution) in a 250 mL glass beaker with a mechanical stirrer at 250 rpm.

An organic phase comprising 80 mL of toluene, was added to the water phase in a dropwise fashion while being mixed with a mechanical stirrer at 600 rpm for 15-20 minutes to create an emulsion.

The resultant emulsion was transferred to a container and sealed, and polymerization was permitted to occur at room temperature for 8 hours to create a solid porous polymer product.

The solid polymer product was removed from the container and rinsed thoroughly with 250 mL of distilled water until the eluent had a pH of between 6 to 7. The solid porous polymer product was immersed in 500 mL acetone for 12 hours and then dried in an oven at 40 ° C. for 8 hours to create the final highly porous polyvinyl alcohol product.

In another example and embodiment, an aqueous phase was prepared by mixing 20 mL of 20% (wt) polyvinyl alcohol (Mw: 13,000-23,000 Da, 98% hydrolyzed), 2 mL of sulfuric acid (1.0 N), 0.5 mL of glutaraldehyde (50% aqueous solution), and 4 mL Triton X-405 (70% aqueous solution) in a 250 mL glass beaker with a mechanical stirrer at 250 rpm.

An organic phase of 80 mL of toluene was added to the water phase in a dropwise fashion while being mixed with a mechanical stirrer at 600 rpm for 15-20 minutes to create an emulsion.

The resultant emulsion was transferred to a container and sealed, and polymerization was permitted to occur at room temperature for 8 hours, to create a solid porous polymer product.

The solid porous polymer product was removed from the container and rinsed thoroughly with 250 mL of distilled water, until the eluent had a pH of between 6-7. The solid porous polymer product was immersed in 500 mL acetone for 12 hours and then dried in an oven at 40° C. for 8 hours to form the highly porous polyvinyl alcohol product.

In a further example, an aqueous phase was prepared by mixing 20 mL of 20% (wt) polyvinyl alcohol (Mw: 13,000-23,000 Da, 98% hydrolyzed), 0.5 mL of glutaraldehyde (50% aqueous solution), and 4 mL Triton X-405 (70% aqueous solution) in a 250 mL glass beaker with a mechanical stirrer at 250 rpm.

An organic phase of 80 mL of toluene and 0.4 gm of maleic anhydride was added in a dropwise fashion to the water phase, while being mixed with a mechanical stirrer at 600 rpm for 15-20 minutes.

The resultant emulsion was transferred to a container and sealed, and polymerization was permitted to occur at room temperature for 8 hours, to create a solid porous polymer product.

The solid porous polymer product was removed from the container and rinsed thoroughly with 250 mL distilled water, until the eluent has a pH of between 6-7. The solid porous polymer product was immersed in 500 mL acetone for 12 hours and then dried in an oven at 40° C. for 8 hours to form a highly porous polyvinyl alcohol product.

In a particular embodiment, it was discovered that the organic phase containing maleic anhydride provided improved control of the crosslinking rate of the linear polyvinyl alcohol during the crosslinking step.

Generally, the process of these examples may include the following. A water phase or aqueous phase is prepared. The water phase typically comprises effective amounts of one linear polymer. In some cases, the polymer may be a soluble polymer (such as a polymer that dissolves or disperses in water). Examples of water soluble polymers include polyvinyl alcohol, polyacrylic acid, polymethacrylic acid, polymaleic acid, and salts thereof. Inclusion of other components in the water phase, such as inclusion of a catalyst (e.g., an inorganic acid and/or organic acid, and/or salts of carboxylic acids), may be a part of the preparation as well.

A crosslinker may be combined with the aqueous phase, such that the aqueous phase contains an uncrosslinked linear polymer and a chemical crosslinker. This step may occur prior to or after the creation of an emulsion. In many of the examples herein, the crosslinker is a chemical substance; but the use of additional methods (such as radiation, agitation or temperature control) that effect crosslinking are not excluded at any stage of the process. As is known, chemical crosslinkers do not have a particular chemical formula or structure, and whether a substance functions as a crosslinker or not is dependent upon the reactants and other conditions. That said, multiple kinds of crosslinkers are known in the art, and (as mentioned previously) some chemical agents such maleic anhydride can promote the crosslinking. There is no particular method or apparatus for combining a crosslinker; many techniques for doing so are known in the art.

In some examples, an organic phase (which may include an oil phase, or which may be deemed a separate phase) is combined with the water phase, forming an emulsion. The resulting emulsion is typically a high internal phase emulsion.

The creation of the emulsion may be followed by (or in some cases, preceded all or in part by) establishing conditions to promote a chemical reaction. Such conditions may include isolation, temperature control (e.g., heating or maintaining at room temperature), agitation, and so on. Such conditions may include actions or agents that may promote crosslinking, such as application of radiation such as electron beam, X-ray, gamma ray and ultraviolet light, and ultrasound. Such conditions may be constant, time-varying, intermittent, applied at particular times or in response to particular conditions, and so forth. The chemical reaction produces the desired porous polymer product, which is subsequently removed or separated from the apparatus. Depending upon the chemicals involved and the conditions and the desired product, the time between creation of the emulsion and the production of the finished product may be brief (e.g., a matter of seconds) or long (e.g., a matter of several hours).

While preferable embodiments of the present disclosure have been shown and described herein, it will be clear to those skilled in the art that such embodiments are provided by way of example only. Numerous variations, changes, and substitutions will now occur to those skilled in the art without departing from the disclosure or the claimed subject matter. It should be understood that various alternatives to the embodiments described herein may be employed. It is intended that the following claims define the scope of the invention and that methods and structures within the scope of these claims and their equivalents be covered thereby.

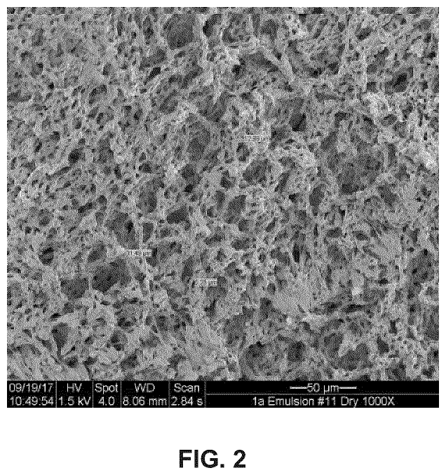

The final products produced by the processes described here may vary in chemical composition, density, color, durability, applicability to particular purposes, and various other physical factors. FIG. 2 is a scanning electron microscope image of an illustrative porous crosslinked hydrophilic polymer product. FIG. 2 shows the size scale. It may be noted that the porosity is evident at this scale, and that the pores (or voids) in the product are not uniformly sized or regularly distributed; but that there are relatively few regions in FIG. 2 in which there is no porosity. Such products generally exhibit enhanced absorbency and may have many uses, some of which have been mentioned already: personal care products, biomedical applications, heavy metal binding, concrete curing, cable waterproof wrapping, horticulture and agriculture, and smart devices such as controlled release vehicles and sensors. These uses are by way of example; the potential uses for such products is virtually limitless.

What is claimed is:

1. A process for the preparation of a porous crosslinked hydrophilic polymeric material comprising:
forming an oil-in-water high internal phase emulsion (HIPE) from an oil phase and an aqueous phase, wherein the aqueous phase comprises at least one hydrophilic polymer and at least one crosslinker capable of crosslinking with the at least one hydrophilic polymer;
causing the crosslinking of the at least one hydrophilic polymer to occur for creating a first crosslinked polymer network; and
removing the oil phase from the first crosslinked polymer network to obtain a porous crosslinked hydrophilic polymeric material.

2. The process of claim 1, wherein a volume ratio between the oil phase and aqueous phase is between the range of 70:30 to 99:1, an amount of the at least one hydrophilic polymer is between about 33% to about 100% by weight of a total amount of the network-forming polymers, and an amount of the at least one crosslinker is between about 0.1% to 50% by weight of the amount of the at least one hydrophilic polymer.

3. The process of claims 1 or 2, further comprising forming a second crosslinked polymer network within the aqueous phase, by copolymerizing at least one water soluble monofunctional ethylenically unsaturated monomer and at least one water soluble polyfunctional ethylenically unsaturated crosslinking monomer, with the copolymerization initiated by a free radical initiator.

4. The process of claim 3, wherein an amount of the at least one water soluble monofunctional ethylenically unsaturated monomer is between the range of about 0% to 67% by weight of a total amount of the network-forming polymers, an amount of the at least one water soluble polyfunctional ethylenically unsaturated crosslinking monomer is between the range of about 0.1% to 20% by weight of the amount of the at least one water soluble monofunctional ethylenically unsaturated monomer, and an amount of the free radical initiator is between the range of about 0.05% to about 10% by weight of the amount of the at least one water soluble monofunctional ethylenically unsaturated monomer.

5. The process of claim 4, wherein copolymerizing the at least one water soluble monofunctional ethylenically unsaturated monomer and at least one water soluble polyfunctional ethylenically unsaturated crosslinking monomer, with the copolymerization initiated by a free radical initiator, further comprises using at least one of a reducing agent and a catalyst, wherein an amount of the at least one reducing agent and a catalyst is between the range of about 0% to about 200% by weight of the amount of the free radical initiator.

6. The process of claim 5, wherein copolymerizing the at least one water soluble monofunctional ethylenically unsaturated monomer and at least one water soluble polyfunctional ethylenically unsaturated crosslinking monomer, with the copolymerization initiated by a free radical initiator, further comprises using at least one of a reducing agent and a catalyst, wherein an amount of the at least one reducing agent and a catalyst is between the range of about 0% to about 100% by weight of the amount of the free radical initiator.

7. The process of claim 5 or 6, wherein the at least one reducing agent and a catalyst is selected from the group consisting of sodium bisulfite, ammonium bisulfite, tetramethylethylenediamine (TMEDA), ferrous sulfate, and mixtures thereof.

8. The process of any one of claims 3 to 7, wherein the water soluble monofunctional ethylenically unsaturated monomer is selected from the group consisting of acrylic acid or salts thereof, methacrylic acid or salts thereof, itaconic acid or salts thereof, 2-Hydroxyethyl acrylate, 2-hydroxyethyl methacrylate, acrylamide, N-isopropylacrylamide, and mixtures thereof.

9. The process of any one of claims 3 to 7, wherein the water soluble monofunctional ethylenically unsaturated monomer is selected from the group consisting of acrylic acid, sodium acrylate, potassium acrylate, and mixtures thereof.

10. The process of any one of claims 3 to 9, wherein the water-soluble polyfunctional ethylenically unsaturated crosslinking monomer is selected from the group consisting of N,N′-Methylenebis(acrylamide) (MBA), ethylene glycol diacrylate (EGDA), poly(ethylene glycol) diacrylate (PEGDA), ethylene glycol dimethacrylate (EGDMA), poly(ethylene glycol) dimethacrylate (PEGDMA), and mixtures thereof.

11. The process of any one of claims 3 to 10, wherein the free radical initiator is selected from the group consisting of potassium persulfate, sodium persulfate, ammonium persulfate, hydrogen peroxide, and mixtures thereof.

12. The process of any one of claims 1 to 11, wherein the aqueous phase further comprises a water soluble catalyst for the crosslinking of the at least one hydrophilic polymer with the at least one crosslinker, the water soluble catalyst having an amount between the range of about 0% to 5% by weight of a total of the aqueous phase.

13. The process of claim 12, wherein the amount of the water soluble catalyst is between the range of about 0.01% to about 3% by weight of the total aqueous phase.

14. The process of claim 12 or 13, wherein the water soluble catalyst is selected from the group consisting of citric acid, phosphoric acid, hydrochloric acid, and mixtures thereof.

15. The process of claim 12 or 13, wherein the water-soluble catalyst is selected from the group consisting of triethylamine and pyridine.

16. The process of claim 12 or 13, wherein the water-soluble catalyst is selected from the group consisting of sodium hydroxide, potassium hydroxide, and mixtures thereof.

17. The process of any one of claims 12 to 16, wherein the aqueous phase further comprises an emulsion surfactant having an amount between the range of about 0% to 15% by weight of the total aqueous phase.

18. The process of any one of claims 12 to 16, wherein the amount of the emulsion surfactant is between the range of about 2% to about 10% by weight of the total aqueous phase.

19. The process of claim 17 or 18, wherein the emulsion surfactant is selected from the group consisting of polyoxyethylene isooctylphenyl ethers with different lengths of the ethylene oxide chain, polyoxyethylene sorbitan fatty acid esters with different lengths of the aliphatic chain of the fatty acid, and mixtures thereof.

20. The process of any one of claims 1 to 19, wherein the at least one hydrophilic polymer is selected from the group consisting of poly(vinyl alcohol) (PVOH) with various degrees of hydrolysis, polyvinyl alcohol (PVOH) copolymers containing carboxylic acid and/or carboxylate salt groups, polyvinyl alcohol (PVOH) copolymers containing sulfonic acid and/or sulfonate salt groups, carboxylated polyvinyl alcohol (PVOH) derivatives, sulfonated polyvinyl alcohol (PVOH) derivatives, poly(2-hydroxyethyl acrylate) (PHEA), poly(2-hydroxyethyl methacrylate) (HEMA), poly(acrylic acid) (PAA) or salts thereof, polyethylene glycol (PEG), carboxymethyl cellulose, hydroxypropyl cellulose, cellulose sulfates, hyaluronic acid or salts thereof, humic acid or salts thereof, starch, lignin sulfonates, copolymers, modified derivatives, and mixtures thereof.

21. The process of any one of claims 1 to 19, wherein the at least one crosslinker capable of crosslinking the at least one hydrophilic polymer is selected from the group consisting of glyoxal, glutaraldehyde (GA), epichlorohydrin (ECH), ethylene glycol diglycidyl ether (EGDGE), poly(ethylene glycol) diglycidyl ether (PEGDGE), ethylenediaminetetraacetic dianhydride (EDTAD), boric acid, sodium borate, and mixtures thereof.

22. The process of any one of claims 1 to 21, wherein an amount of the at least one crosslinker is between the range of about 0.2% to about 40% by weight of the total amount of the at least one hydrophilic polymer.

23. The process of any one of claims 1 to 22, wherein the at least one crosslinker capable of crosslinking the at least one hydrophilic polymer is selected from the group consisting of epichlorohydrin (ECH), ethylene glycol diglycidyl ether (EGDGE), poly(ethylene glycol) diglycidyl ether (PEGDGE), glyoxal, glutaraldehyde (GA), ethylenediaminetetraacetic dianhydride (EDTAD),adipic acid dihydrazide, and mixtures thereof.

24. The process of any one of claims 1 to 22, wherein the at least one crosslinker capable of crosslinking the at least one hydrophilic polymer is a functionalized clay with the smallest dimension of particles in the range of from 1 nm to 100 pm.

25. The process of any one of claims 1 to 24, wherein the oil phase comprises an oil selected from the group consisting of benzene, toluene, xylene, hexane, heptane, octane, nonane, decane, undecane, dodecane, pentadecane, hexadecane, mineral oil, silicone oil, dichloromethane, and mixtures thereof.

26. The process of any one claims 1 to 24, wherein the oil phase comprises an oil selected from the group consisting of soybean oil, corn oil, canola oil, sunflower oil, cottonseed oil, peanut oil, and mixtures thereof.

27. The process of any one of claims 1 to 26, wherein removing the oil phase further comprises washing the porous crosslinked hydrophilic polymeric material with a liquid selected from the group consisting of acetone, methanol, water, aqueous solution containing a base, aqueous solution containing a carbonate, aqueous solution containing a bicarbonate, dish detergent and mixtures thereof.

28. The process of any one of claims 1 to 27, wherein the aqueous phase an ingredient that confers desired characteristics during at least one of processing a final product and properties of the final product, the ingredient selected from the group consisting of a solubility modifier, a viscosity modifier, an antioxidant, at least one of a dye and a pigment, a fluorescer, a filler, a fiber, an odor absorbent, and mixtures thereof.

29. The process of any one of claims 1 to 28, wherein the oil phase further comprises an ingredient that confers desired characteristics during at least one of processing a final product and properties of the final product, the ingredient selected from the group consisting of a solubility modifier, a viscosity modifier, and mixtures thereof.

30. The process of any one of claims 1 to 29, further comprising post-treating the porous crosslinked hydrophilic polymeric material.

31. The process of claim 30 wherein post-treating the porous crosslinked hydrophilic polymeric material further comprising treating the porous crosslinked hydrophilic polymeric material with a base, treating with a carbonate, treating with a bicarbonate, sulfonation, and mixtures thereof.

32. The process of any one of claims 1 to 29, further comprising drying the porous crosslinked hydrophilic polymeric material.

33. The process of claim 32, wherein drying the porous crosslinked hydrophilic polymeric material is air drying, drying in a conventional oven, drying in a convection oven, drying in a vacuum oven, solvent exchange, freeze drying, and mixtures thereof.

34. The process of any one of claims 1 to 33, wherein causing the crosslinking of the at least one hydrophilic polymer which was contained in the HIPE to occur for creating a first crosslinked polymer network at a temperature between the range of about 20° C. to about 80° C.

35. The process of claim 34, wherein heating the HIPE in which at least one hydrophilic polymer was contained and the at least one crosslinker at a temperature between the range of about 40° C. to about 60° C.

36. The process of any one of claims 1 to 35, wherein the process is carried out in a batch production.

37. The process of any one of claims 1 to 35, wherein wherein the process is carried out in a continuous production.

38. A porous crosslinked hydrophilic polymeric material produced by the process of any one of claims 1 to 37.
